(19) United States
(12) Patent Application Publication
(10) Pub. No.: US 2010/0194117 A1
(43) Pub. Date: Aug. 5, 2010

(54) ELECTROMAGNETIC DEVICE HAVING COMPACT FLUX PATHS FOR HARVESTING ENERGY FROM VIBRATIONS

(75) Inventors: Jahir A. Pabon, Newton, MA (US); Julio Guerrero, Cambridge, MA (US); Joachim Sihler, Cheltenham (GB); Jeffrey H. Lang, Sudbury, MA (US); Alex Slocum, Bow, NH (US); Zachary Trimble, Arlington, MA (US); Hongshen Ma, Vancouver (CA)

Correspondence Address: SCHLUMBERGER-DOLL RESEARCH;ATTN: INTELLECTUAL PROPERTY LAW DEPARTMENT, P.O. BOX 425045, CAMBRIDGE, MA, 02142, US

(73) Assignee: Schlumberger Technology Corporation, Cambridge, MA (US)

(21) Appl. No.: 12/366,119

(22) Filed: Feb. 5, 2009

(51) Int. Cl. F03G 7/08; H02K 41/035

(52) U.S. Cl. 290/1 R; 310/12.12

(57) ABSTRACT

Electrical energy is produced by harvesting mechanical energy in the form of vibrations which are generally present in tools during the process of drilling oil wells. Electrical energy production is based on the Faraday induction principle whereby changes, i.e., movement, in magnetic flux through a coil induce an electric current through the coil. The changes in magnetic flux are produced by relative motion between at least one set of magnets and at least one coil. In particular, as the flux lines change due to the movement of the magnets, they remain perpendicular to both the direction of motion of the magnets as well as a planar or cylindrical surface defined by the coils. As a result, output for a given size of device is enhanced. Further, flexibility in adapting device form factor to particular shapes is enhanced. For example, a relatively flat device may be implemented using flexural bearing support of the magnets and coils on a printed circuit. The flexural bearings may also function as spring members that define the resonant frequency of the device. Alternative embodiments may be characterized by cylindrical or annular form factors.

### FIELD OF THE INVENTION

This invention is generally related to energy harvesting, and more particularly to converting kinetic energy from flowing fluid into electrical energy to power equipment in a remote location.

### BACKGROUND OF THE INVENTION

In order to recover natural resources from subterranean formations it is often necessary to perform tasks related to exploration, monitoring, maintenance and construction in remote locations that are either difficult or impractical for personnel to reach directly. For example, boreholes may be drilled tens of thousands of meters into the earth, and in the case of offshore drilling, the borehole itself may be thousands of meters under water. One of the technical challenges to performing tasks in such remote locations is providing power to equipment. It is known to power downhole and undersea equipment via either stored energy or wireline connection to the surface. However, both of these techniques have disadvantages. For example, a wireline connection to the surface limits the distance at which the equipment can operate relative to the energy source because there are practical limits to the length of a wireline connection. A wireline connection may also require a relatively significant portion of the limited volume of a borehole. Using stored energy avoids some of the disadvantages of using a wireline connection to the surface, but relatively little energy can be stored because of size limitations. For example, the available volume in a borehole environment is relatively small for a battery having relatively large storage capacity. Further, both wireline connections to the surface and stored energy techniques require the presence of operators, e.g., a surface vessel to either provide the wireline energy or recharge the energy storage means. It would therefore be desirable to have a compact device capable of generating power in a remote location without need for physical connection with the surface or retrieval for recharge.

Various techniques are known for converting the kinetic energy associated with flowing fluid into electrical energy. For example, fluid flow can be utilized to actuate propellers or turbines in order to operate an electric generator. However, propellers and turbines are typically not robust enough to operate reliably in the downhole environment over long periods of time. Techniques based on a shaking motion are also known. For example, U.S. Pat. No. 6,220,719 describes a flashlight powered by a magnet and coil mechanism based on the Faraday principle. In particular, electrical current flow is induced by axial shaking of the flashlight body because the magnet has a polarization which is parallel to the direction of relative motion between the magnet and the coils. One limitation of the design is that the amplitude of magnet movement must be similar to the length of the coil in order to generate appreciable changes in magnetic flux through the coil. Because the dimensions of the device for a given level of output are limited by this feature, it may not be practical to generate sufficient electrical power in the borehole environment with such a design.

U.S. Pat. No. 6,768,230 describes a design in which two or more magnets are used inside the coil to enhance harvesting efficiency versus movement amplitude. However, the induced currents from each magnet could be in direct opposition depending on the motion of the individual magnets, thereby reducing the net current at the ends of the coil. Additionally, the axis of polarization of the magnets is parallel to the direction of relative motion, thereby limiting the effective coupling and compactness for a given level of output.

U.S. Pat. No. 7,288,860 describes a variation in which multiple coils are used. However, the net current induced can still be reduced as described above because of the independent movement of the magnets. Further, the axis of polarization of the magnets is parallel to the direction of relative motion, thereby limiting effective coupling and compactness for a given level of output.

### SUMMARY OF THE INVENTION

In accordance with an embodiment of the present invention, apparatus for converting mechanical energy into electrical energy comprises: at least one coil defining a surface; a plurality of magnets arranged with respect to the at least one coil such that magnetic flux from the magnets induces an electric current through the coil in response to relative motion between the magnets and at least one coil over a range of motion, wherein magnetic lines of flux from the magnets through the at least one coil are predominantly perpendicular to both the surface of the coils and direction of relative motion between the at least one coil and magnets over the range of motion.

In accordance with another embodiment of the invention, a method for converting mechanical energy into electrical energy comprises: with at least one coil defining a surface and a plurality of magnets arranged with respect to the at least one coil such that magnetic flux from the magnets induces an electric current through the coil in response to relative motion between the magnets and at least one coil over a range of motion, controlling relative motion between the magnets and at least one coil such that magnetic lines of flux from the magnets through the at least one coil are perpendicular to both the surface of the coils and direction of relative motion between the at least one coil and magnets over the range of motion.

One advantage of the invention is that it can be used to implement a device for generating a given level of electrical energy output in a smaller volume of space for a given vibrational input. Unlike the typical prior art designs, the polarization axis, of the magnets is perpendicular to the direction of relative motion, and also perpendicular to a surface defined by the coils. Further, the magnets are arranged so that adjacent magnets are characterized by opposite polarizations (illustrated with S and N). Magnetically permeable plates may be employed to further enhance the compactness of the path traversed by lines of magnetic flux. This configuration provides improved coupling of energy from the relative motion between magnets and coils relative to the prior art. This is an advantage for downhole applications where space is limited.

Another advantage of the invention is enhanced flexibility in adapting device form factor to particular shapes. A relatively flat device may be implemented using flexures, i.e., compact structures made up of beams arranged in a zig-zag or other pattern to support the magnets and coils on a printed circuit. The flexures may also function as spring members that define the resonant frequency of the device. The flexures can be appropriately designed to reduce the movement of the magnets in other directions. Alternative embodiments may be characterized by cylindrical or annular form factors. For example, the coils and magnets may be controlled in an arcuate motion rather than a linear motion. Alternatively, radially polarized annular ring magnets may be used.

These and other advantages of the invention will be more apparent from the detailed description and the drawing.

### BRIEF DESCRIPTION OF THE FIGURES

FIG. 1 illustrates a wellsite system in which the present invention can be employed.

FIG. 2 is a schematic/block representation of the energy harvesting device.

FIG. 3 illustrates change in relative position between the magnets and coils during operation of the energy harvesting device.

FIG. 4 illustrates the coil windings in greater detail.

FIGS. 5 and 6 illustrate an alternative embodiment of the energy harvesting device in which the spring members include flexures.

FIG. 7 illustrates an alternative embodiment of the energy harvesting device including adaptations to fit into an outer groove of a cylindrical structure.

FIG. 8 illustrates an alternative embodiment of the energy harvesting device characterized by a cylindrical form factor.

FIG. 9 illustrates an alternative embodiment of the energy harvesting device which includes a second mass-spring system to enhance operation over a wider range of vibration frequencies.

FIG. 10 illustrates an alternative embodiment which includes a second set of coils.

### DETAILED DESCRIPTION

The particulars described herein are for purposes of discussion of the illustrated embodiments of the present invention in order to provide what is believed to be a useful and readily understood description of the principles and conceptual aspects of the invention. No attempt is made to show structural aspects of the invention in more detail than is necessary for a fundamental understanding of the invention. The invention may be implemented in various different embodiments of a device for converting kinetic energy from the surrounding environment into electrical energy. The embodiments are described below in the context of the source of kinetic energy being vibrations of a drilling tool such as those associated with drilling oil wells. However, the invention is not limited to petrochemical wells.

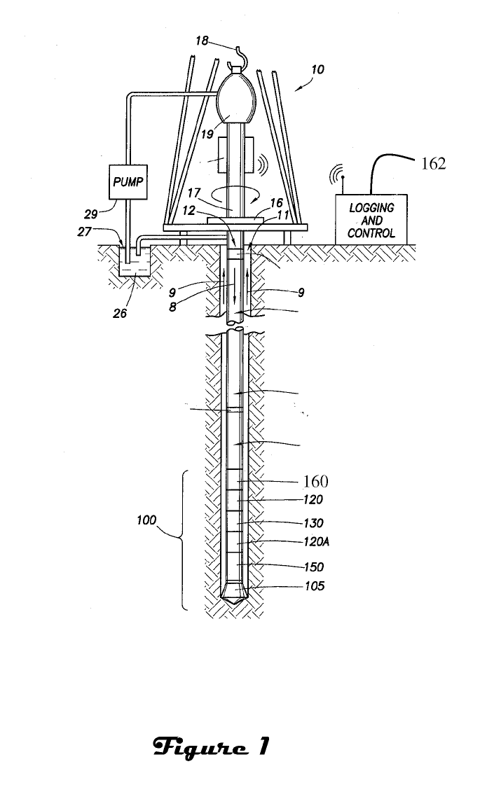

FIG. 1 illustrates a wellsite system in which the present invention can be employed. The wellsite can be onshore or offshore. In this exemplary system, a borehole (11) is formed in subsurface formations by rotary drilling in a manner that is well known. Embodiments of the invention can also use directional drilling, as will be described hereinafter.

A drill string (12) is suspended within the borehole (11) and has a bottom-hole assembly (100) which includes a drill bit (105) at its lower end. The surface system includes platform and derrick assembly (10) positioned over the borehole (11), the assembly (10) including a rotary table (16), kelly (17), hook (18) and rotary swivel (19). The drill string (12) is rotated by the rotary table (16), energized by means not shown, which engages the kelly (17) at the upper end of the drill string. The drill string (12) is suspended from a hook (18), attached to a traveling block (also not shown), through the kelly (17) and a rotary swivel (19) which permits rotation of the drill string relative to the hook. As is well known, a top drive system could alternatively be used.

In the example of this embodiment, the surface system further includes drilling fluid or mud (26) stored in a pit (27) formed at the well site. A pump (29) delivers the drilling fluid (26) to the interior of the drill string (12) via a port in the swivel (19), causing the drilling fluid to flow downwardly through the drill string (12) as indicated by the directional arrow (8). The drilling fluid exits the drill string (12) via ports in the drill bit (105), and then circulates upwardly through the annulus region between the outside of the drill string and the wall of the borehole, as indicated by the directional arrows (9). In this well known manner, the drilling fluid lubricates the drill bit (105) and carries formation cuttings up to the surface as it is returned to the pit (27) for recirculation.

The bottom-hole assembly (100) of the illustrated embodiment includes a logging-while-drilling (LWD) module (120), a measuring-while-drilling (MWD) module (130), a roto-steerable system and motor, energy harvester (160), and drill bit (105). The LWD module (120) is housed in a special type of drill collar, as is known in the art, and can contain one or a plurality of known types of logging tools. It will also be understood that more than one LWD and/or MWD module can be employed, e.g. as represented at (120A). (References, throughout, to a module at the position of (120) can alternatively mean a module at the position of (120A) as well.) The LWD module includes capabilities for measuring, processing, and storing information, as well as for communicating with the surface equipment. In the present embodiment, the LWD module includes a pressure measuring device.

The MWD module (130) is also housed in a special type of drill collar, as is known in the art, and can contain one or more devices for measuring characteristics of the drill string and drill bit. The MWD tool further includes an apparatus (not shown) for generating electrical power to the downhole system. This may typically include a mud turbine generator powered by the flow of the drilling fluid, it being understood that other power and/or battery systems may be employed. In the present embodiment, the MWD module includes one or more of the following types of measuring devices: a weight-on-bit measuring device, a torque measuring device, a vibration measuring device, a shock measuring device, a stick slip measuring device, a direction measuring device, and an inclination measuring device.

The energy harvesting device (160) may be affixed to some portion of a drilling tool. The device (160) functions to convert the kinetic energy from the vibrations of the drilling tool into electrical energy. The present invention is concerned with converting the vibrations to electrical energy. In particular, the invention concerns reducing the dimensions required for a device to convert vibrations to produce a given amount of electrical energy. Electrical energy storage means may be provided to help accumulate the generated energy.

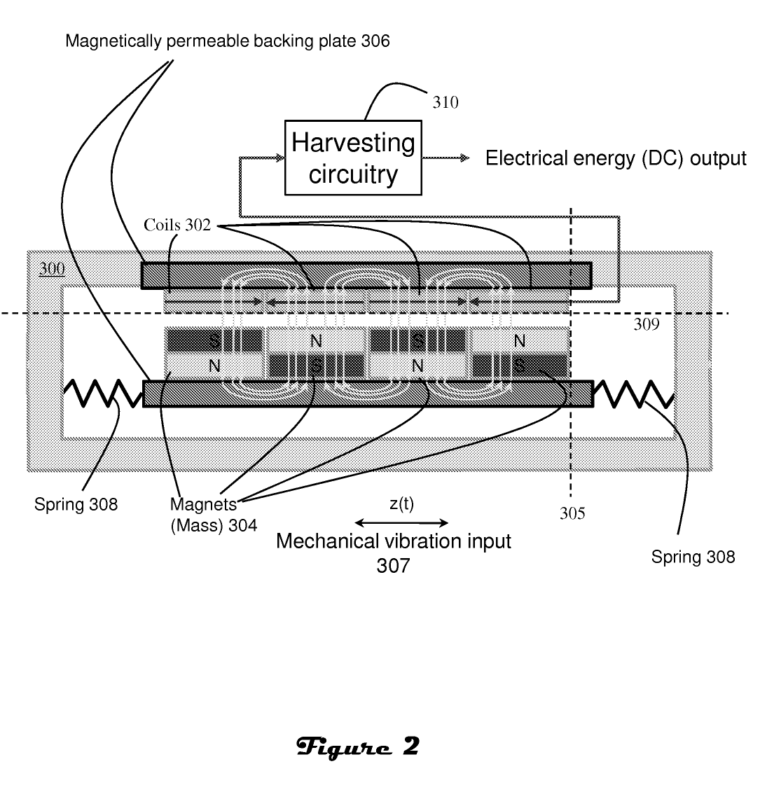

FIG. 2 illustrates a schematic representation of an embodiment of the device (160). This embodiment includes a housing (300), one or more coils (302), magnets (304), magnetically permeable backing plates (306), spring members (308), and harvesting circuitry (310). The magnets (304) move relative to the coils (302) in response to vibration so as to induce electric current through the coils, i.e., vibrations may induce movement in the coils, magnets, or both. Bearings may be used to support and/or guide the coils, magnets, or both while permitting movement in the desired direction.

Unlike the typical prior art design, the polarization axis (305) of the magnets is perpendicular to the direction of relative motion (307), and also perpendicular to a surface (309) defined by the coils (a planar surface in the illustrated embodiment). Further, the magnets are arranged so that adjacent magnets are characterized by opposite polarizations (illustrated with S and N). The magnetically permeable plates (306) further enhance the magnetic flux traversing the coils relative to, e.g., air. This configuration provides improved coupling of energy from the relative motion between magnets and coils relative to the prior art. Consequently, the device can generate a given level of electrical energy output in a smaller volume of space for a given vibrational input. This is an advantage for downhole applications where space is limited.

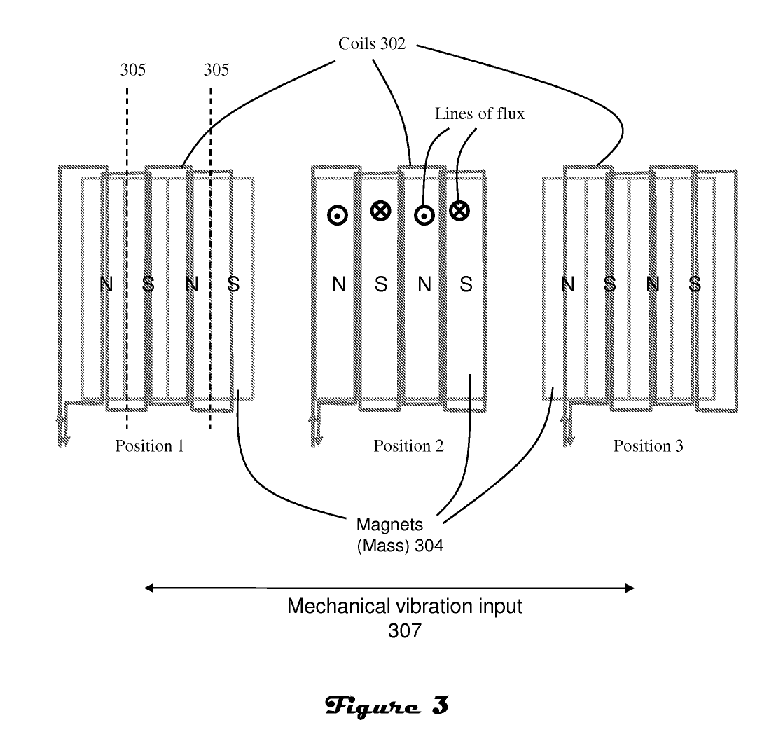

FIG. 3 illustrates change in relative position between the magnets (304) and coils (302) during operation of the energy harvesting device. Starting at position 1, operation proceeds to position 2, then to position 3. From position 3, the device returns to position 2 and then proceeds back to position 1. The cycle is then repeated. Note that the polarization axis (305) of the magnets is perpendicular to the direction of relative motion (307) and to the planar surface of the coils, and also that adjacent magnets are characterized by opposite polarizations. As indicated by the different positions, only a small amount of relative motion between magnets and coils is required to induce current flow, thereby allowing a more compact form factor of the overall energy harvester.

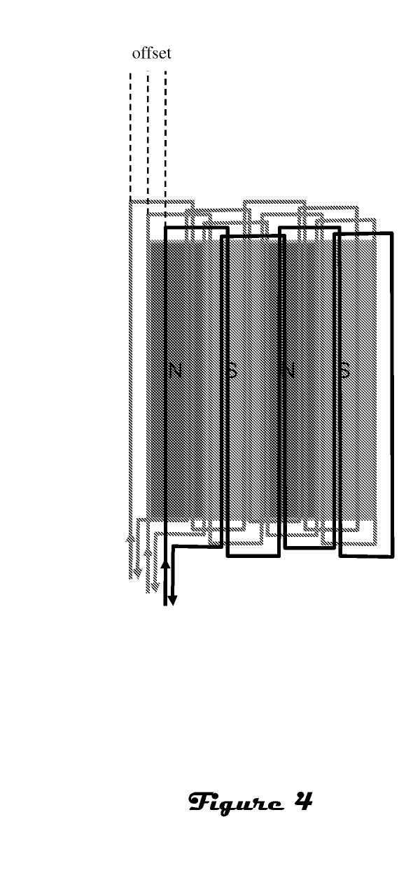

FIG. 4 illustrates the coil windings in greater detail. Note that multiple staggered coils are used, e.g., three separate coils in the specifically illustrated example. The coils are disposed with respect to each other and the set of magnets so as to generate separate alternating currents of different phase in each coil, e.g., three coils with relative phases of 0, 120 and 240 degrees. This is accomplished by selecting an appropriate offset between adjacent coils. In particular, the coils are fixed relative to one another, and offset by a distance proportional to the dimensions of the magnets such that the various induced currents are offset in terms of phase. The generation of alternating currents of different phase advantageously mitigates ripple effects on the electric circuit. As in the previous embodiment, the polarization axis of the magnets is perpendicular to the direction of relative motion, and also perpendicular to the planar surface of the coils.

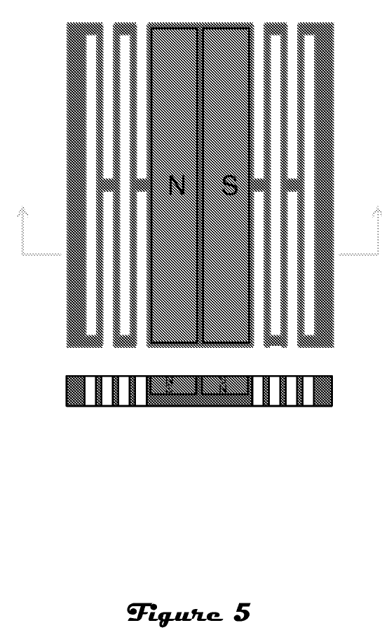

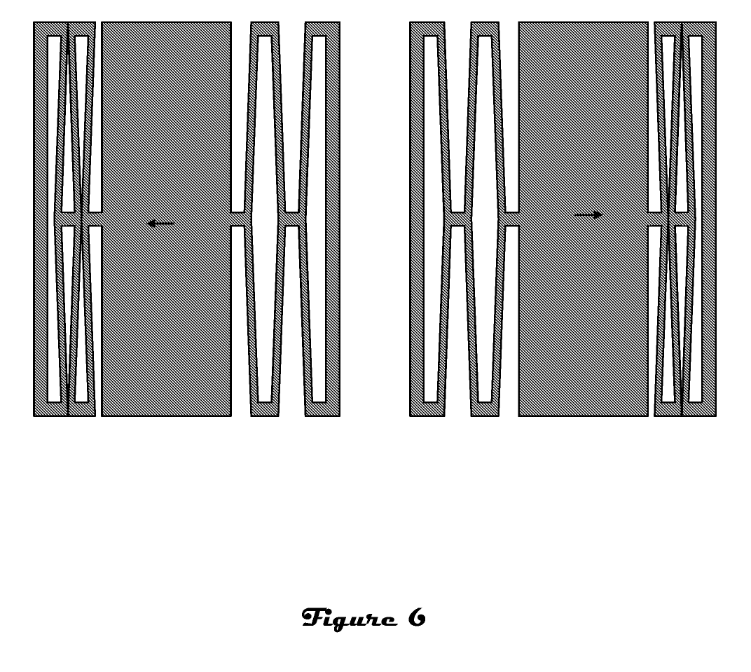

As illustrated in FIGS. 5 and 6, in an alternative embodiment the spring members (308, FIG. 2) may be flexures, i.e., networks of interconnected beams. One advantage of using flexures is that they can perform the dual functions of providing spring force and highly constraining movement in other undesired directions, such as up/down in FIG. 3. By selecting an appropriately large characteristic ratio between the height and the width of the beam cross-sections, e.g., (>5), (shown specifically in the lower part of FIG. 5), it is possible to mitigate out of plane movement of the magnets. In other words, the magnet structure “floats” in front of the coils because the flexure provides support which prevents or appreciably reduces movement in directions other than the one used to induce current on the coils. This helps reduce or eliminate the need to use bearings or other guiding mechanisms which typically add complexity and reduce energy efficiency because of friction losses. It will also be appreciated that flexures can be physically compact. For example, the beam thickness may be quite small relative to beam height and width, i.e., a substantially flat structure. This also helps to reduce the form factor of the energy harvesting device.

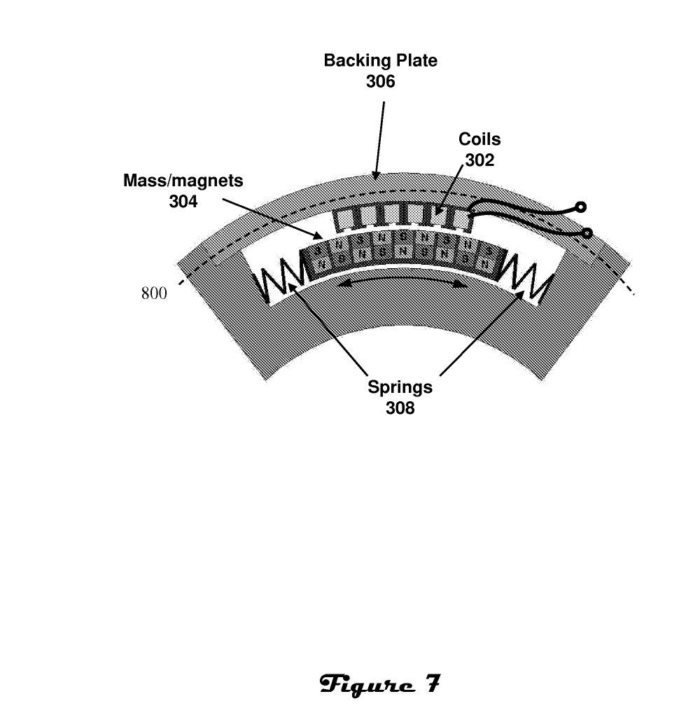

Although a relatively flat design is described above, it should be noted that aspects of the invention also facilitate implementation of the energy harvesting device in other form factors which may be preferable for certain applications. For example, FIG. 7 illustrates an embodiment of the energy harvesting device adapted to fit into an outer groove of a cylindrical structure. This embodiment of the energy harvesting device may include one or more sections (only one section of the device is shown). For example, the device may include multiple sections disposed end-to-end in a circular arrangement. The resulting device may have an arcuate or annular form factor. Note that in the illustrated section, the coils (302), magnets (304), and magnetically permeable backing plate (306) are disposed along an arc (800) when viewed in two dimensions, corresponding to a cylindrical surface or some portion thereof in three dimensions. Further, the relative motion between the coils and magnets is along the arc such that the distance between the coils as a unit and the magnets as a unit is stable. Hence, the coils define a cylindrical surface (or a portion of a cylindrical surface), and as the flux lines “move” or change due to the movement of the magnets, they remain perpendicular to both the direction of motion of the magnets as well as the cylindrical surface of the coils. Springs (308) are selected to achieve a desired resonant frequency.

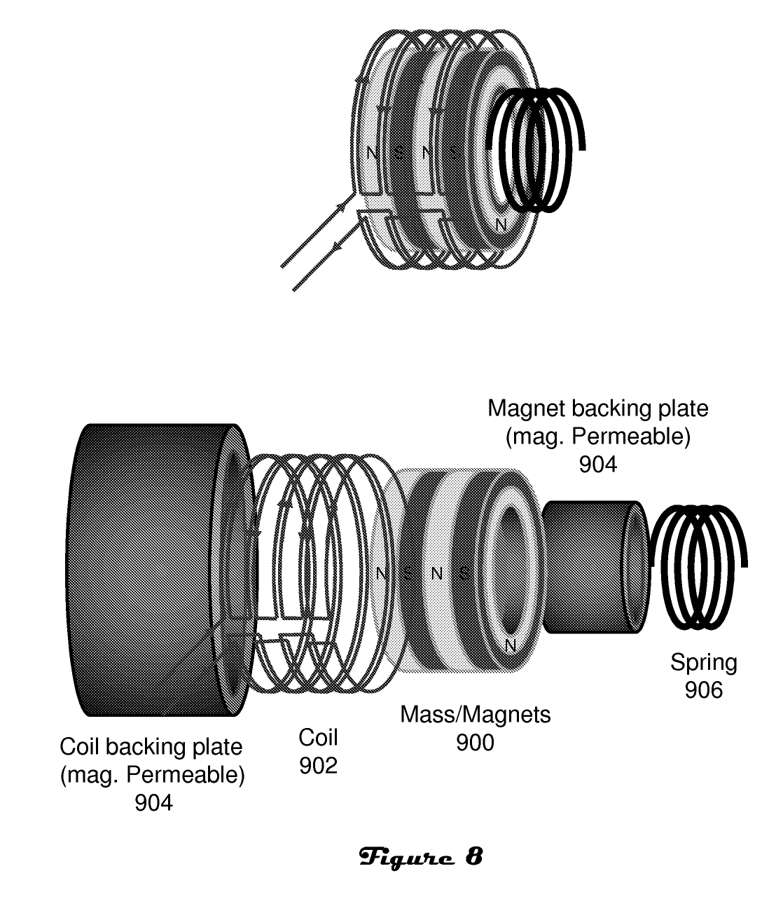

FIG. 8 illustrates an alternative embodiment of the energy harvesting device characterized by a cylindrical form factor. This embodiment includes a plurality of stacked annular magnets (900), each of which is radially polarized. In particular, the radial polarization of adjacent magnets in the stack is alternated. The coil (902) is wound in partial wraps around the magnets, and disposed so as to enhance or even maximize the magnetic flux changes as the magnets move along an axis defined by the cylinder. Cylindrical magnetically permeable backing plates (904) are disposed around the coils and with the stacked cylindrical magnets, respectively. A spring (906) is selected to achieve a desired resonant frequency.

The embodiments described above are particularly well suited to implementation where the source of vibration (represented as the signal z(t) in FIG. 2) is of a narrow band nature, and the device is made to resonate at the characteristic frequency of the input vibration. That is, if the mass of the moving magnet structure and the stiffness of the springs connecting that magnet structure to the housing of the device are selected such that the resonant frequency of the mass-spring system coincides with the center frequency of the vibration input, enhanced or optimal performance may result. Narrow band sources of vibration can result from resonances of mechanical structures. For implementations where the source of vibration is defined by broader frequency band, the energy harvesting performance of the device can be enhanced with one or more modifications. One such modification is use of springs characterized by a non-linear spring constant. Non-linearity may be accomplished by positioning appropriately polarized magnets proximate to the extreme position of the spring in a cycle.

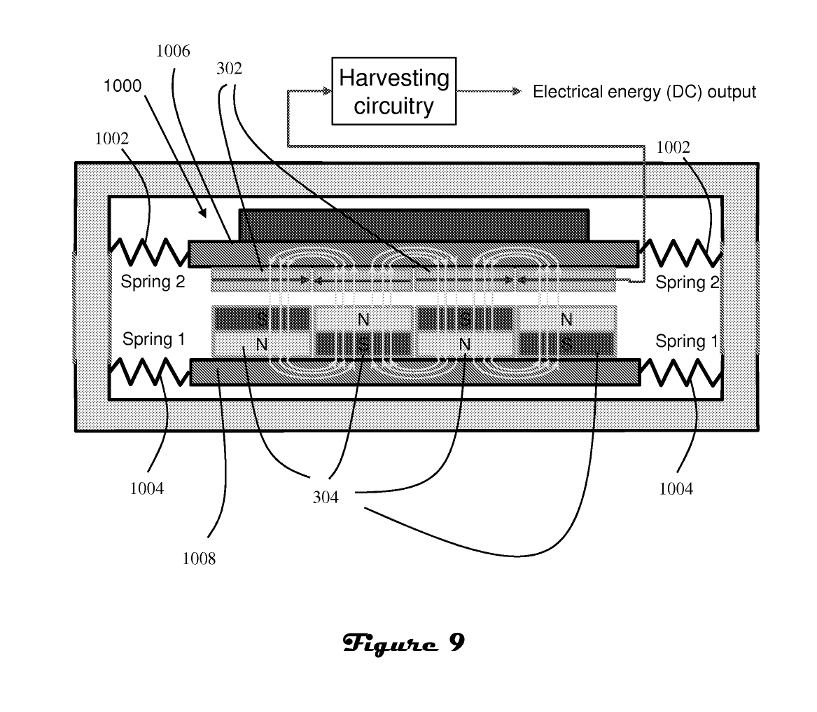

Another modification for enhanced operation over a wider range of vibration frequencies is a second mass-spring system (1000), such as illustrated in FIG. 9. Note that both the coils (302) and the magnets (304) move in response to vibration, and that the movement is controlled by separate sets of springs (1002, 1004) and masses (1006, 1008). Typically, the springs and masses are selected such that the device is capable of harvesting energy more effectively between two resonant frequencies. The two resonant frequencies are given by the two mass-spring resonances of the magnet and coil structures. The use of non-linear springs in this configuration could further enhance the harvesting performance of the device.

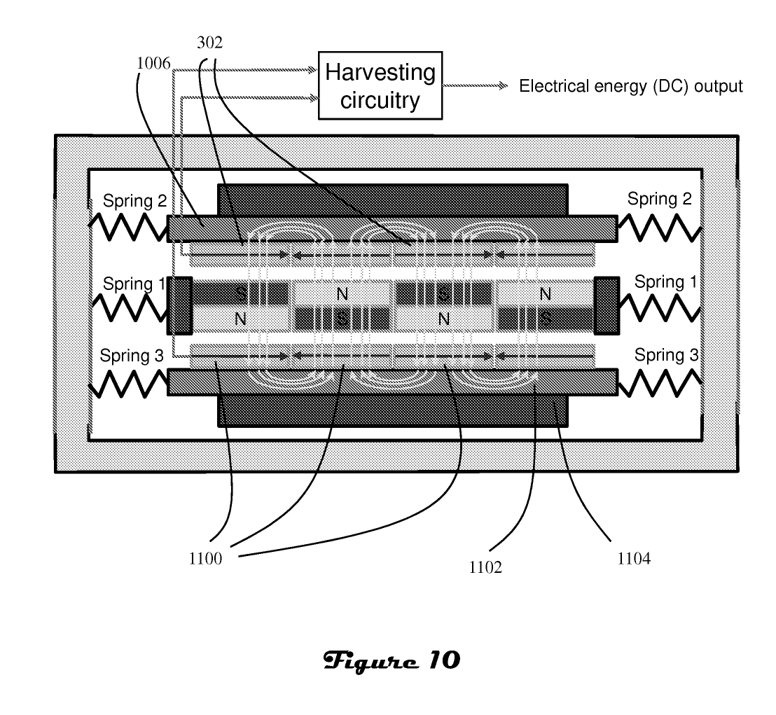

A further modification of the embodiment of FIG. 9, illustrated in FIG. 10, is to include a second set of coils (1100) such that the magnets are disposed between the sets of coils. The second set of coils (1100) is associated with a separate mass (1102) and magnetically permeable backing plate (1104). In this configuration the mass-spring resonance of the magnets is to be either lower or higher than the resonances of the two coil structures. Again, using non-linear springs could further enhance the performance.

While the invention is described through the above exemplary embodiments, it will be understood by those of ordinary skill in the art that modification to and variation of the illustrated embodiments may be made without departing from the inventive concepts herein disclosed. Moreover, while the preferred embodiments are described in connection with various illustrative structures, one skilled in the art will recognize that the system may be embodied using a variety of specific structures. Accordingly, the invention should not be viewed as limited except by the scope and spirit of the appended claims.

What is claimed is:

1. Apparatus for converting mechanical energy into electrical energy, comprising:
at least one coil defining a surface;
a plurality of magnets arranged with respect to the at least one coil such that magnetic flux from the magnets induces an electric current through the coil in response to relative motion between the magnets and at least one coil over a range of motion, wherein magnetic lines of flux from the magnets through the at least one coil are perpendicular to both the surface of the coils and direction of relative motion between the at least one coil and magnets over the range of motion.

2. The apparatus of claim 1 wherein the magnets are arranged so that adjacent magnets are characterized by opposite polarizations.

3. The apparatus of claim 1 further including at least one magnetically permeable plate adjacent to the at least one coil.

4. The apparatus of claim 1 further including at least one magnetically permeable plate adjacent to the magnets.

5. The apparatus of claim 1 wherein the at least one coil includes a plurality of coils disposed with respect to each other and the magnets so as to generate separate alternating currents of different phase in each coil.

6. The apparatus of claim 5 wherein the coils are fixed relative to one another, and offset by a distance proportional to dimensions of the magnets.

7. The apparatus of claim 1 further including at least one spring member that controls the range of relative motion and defines a resonant frequency of the apparatus.

8. The apparatus of claim 7 wherein the at least one coil is attached to a mass, and the spring member is attached to the mass.

9. The apparatus of claim 7 wherein the magnets are attached to a mass, and the spring member is attached to the mass.

10. The apparatus of claim 7 wherein the spring member includes a flexure.

11. The apparatus of claim 10 wherein the flexures supports the coil, the magnet, or both the coil and the magnet to prevent or appreciably reduce movement in directions other than the one used to induce current on the coils, and thus eliminating the need to use bearings or other guiding mechanisms.

12. The apparatus of claim 1 wherein the surface defined by the coils is planar.

13. The apparatus of claim 1 wherein the surface defined by the coils is cylindrical.

14. The apparatus of claim 1 wherein the surface defined by the coils is a portion of a cylinder.

15. The apparatus of claim 1 wherein the magnets are characterized by an annular shape.

16. The apparatus of claim 15 wherein the magnets are radially polarized.

17. The apparatus of claim 16 wherein radial polarization of adjacent magnets in the stack is alternated.

18. The apparatus of claim 17 wherein the at least one coil is wound in partial wraps around the magnets.

19. The apparatus of claim 7 wherein the spring member is characterized by a non-linear spring constant.

20. The apparatus of claim 1 further including at least first and second spring members, the first spring member controlling motion of the at least one coil and the second spring member controlling motion of the magnets.

21. The apparatus of claim 20 wherein motion of the coil is characterized by a different resonant frequency than motion of the magnets.

22. The apparatus of claim 1 including first and second sets of coils, wherein the magnets are disposed between the first and second sets of coils.

23. The apparatus of claim 22 further including a separate mass and magnetically permeable backing plate for each of the first and second sets of coils.

24. The apparatus of claim 22 wherein first and second spring members are associated with the first and second sets of coils, respectively.

25. The apparatus of claim 24 wherein the first and second sets of coils are characterized by different resonant frequencies.

26. The apparatus of claim 25 wherein a third spring member is associated with the magnets.

27. The apparatus of claim 26 wherein the magnets are characterized by a different resonant frequency which is either higher or lower than the resonant frequencies of both sets of coils.

28. A method for converting mechanical energy into electrical energy, comprising:
with at least one coil defining a surface and a plurality of magnets arranged with respect to the at least one coil such that magnetic flux from the magnets induces an electric current through the coil in response to relative motion between the magnets and at least one coil over a range of motion, controlling relative motion between the magnets and at least one coil such that magnetic lines of flux from the magnets through the at least one coil are perpendicular to both the surface of the coils and direction of relative motion between the at least one coil and magnets over the range of motion.

29. The method of claim 28 wherein the at least one coil includes a plurality of coils, and including generating a plurality of alternating currents of different phase in each coil.

30. The method of claim 28 including controlling relative motion between the magnets and at least one coil with at least one spring member that defines a resonant frequency.

31. The method of claim 28 including controlling relative motion between the magnets and at least one coil with at least one spring member and at least one mass that define a resonant frequency.

32. The method of claim 28 including confining relative motion between the magnets and at least one coil to a linear range of motion.

33. The method of claim 28 including confining relative motion between the magnets and at least one coil to an arcuate range of motion.

34. The method of claim 28 including controlling relative motion between the magnets and at least one coil with at least one spring member characterized by a non-linear spring constant.

35. The method of claim 28 including controlling relative motion between the magnets and at least one coil with at least first and second spring members, the first spring member controlling motion of the at least one coil and the second spring member controlling motion of the magnets.

36. The method of claim 35 including controlling motion of the coil and controlling motion of the magnets at a different resonant frequencies.

37. The method of claim 28 including first and second sets of coils, wherein the magnets are disposed between the first and second sets of coils, wherein first and second spring members are associated with the first and second sets of coils, respectively, and including controlling the first and second sets of coils at different resonant frequencies.

38. The method of claim 37 wherein a third spring member is associated with the magnets, and including controlling the magnets at a different resonant frequency than the first and second sets of coils.
